(19) United States
(12) Patent Application Publication
(10) Pub. No.: US 2011/0288685 A1
(43) Pub. Date: Nov. 24, 2011

(54) System for Storage of Articles in a Secured Area

(76) Inventor: Ruth B. Usem, Minneapolis, MN (US)

(21) Appl. No.: 12/786,083

(22) Filed: May 24, 2010

(51) Int. Cl. G05B 15/00; B65D 55/14

(52) U.S. Cl. 700/275; 70/159

(57) ABSTRACT

A storage system includes storage units for securely retaining articles therein. The storage system includes an electronic user identification system to insure that the individual storing articles therein is the same individual removing the articles there from. The user identification system also compares the user identification information with database information to determine if the user is permitted to use the storage unit or not. The storage system provides such information to security personnel so that improper use of the storage system can be identified and appropriate action taken.

### 1. FIELD OF THE INVENTION

The present invention relates generally to storage lockers and more particularly to storage lockers that permit temporary storage in secured areas and provide for identification of the contents and the owner thereof.

### 2. BACKGROUND OF THE INVENTION

Storage lockers are well known in the art and can provide for temporary secure holding of personal items in areas such as airports, shopping malls, amusement parks and the like. Lockers of this kind are generally operated wherein the user, after depositing items therein, closes the door thereof and deposits a required amount of money after which a key can be removed. The key is then used at a later time to retrieve the locker contents. In addition to coins, it is now possible to pay the locker rental fee with paper money or by credit card.

However, this type of locker system has fallen into disfavor in secure areas such as airport terminals and particularly the departure and arrival gate areas thereof. The problem is that it is not possible to know what is in the locker nor the identity of the owner thereof. Thus, it has been possible for individuals to use such lockers for criminal or terroristic purposes by placing therein all manner of contraband for later use by themselves or others. For this reason lockers are being removed from airports and other public areas where security is a concern. Nevertheless, travelers have a wide range of personal items including luggage and other carry on items that they need to keep in their possession and under their supervision at all times. However, if an individual has a long time between flights and would like to nap or otherwise take a quick meal or use a restroom, keeping all their possessions safe and under their supervision can be very problematic, if not impossible. Accordingly, it would be very desirable to have a temporary storage system for travelers and those in other situations or areas where security is a concern that permits such storage and that also satisfies any applicable safety and security regulations and requirements.

### SUMMARY OF THE INVENTION

The present invention is a secure storage system for temporarily storing various personal items in a manner that is secure but that limits the ability of a person storing such items to hide their personal identity. The storage locker herein defines a storage space having a locking door that permits access to and removal of items placed therein. The door is either fully or partially transparent so that the contents of the locker can be viewed when in its closed and locked position. A plurality of such lockers can be arranged in various ways, such as for example; linearly alongside each other, in a circular carousel manner or with rows thereof stacked one above the other. In one form of the invention herein the lockers are placed at ground level to easily facilitate rolling of wheeled luggage therein.

In one security embodiment of the invention herein, the rental fee for the storage locker is made payable only by credit card. Thus, a credit card reader is used along with a microprocessor based electronic control board to identify and control the storage use of a plurality of lockers. Each locker includes an electro-mechanical locking mechanism for locking the door after the contents are placed in the storage space, the door closed and the user's credit card has been swiped and authorized. The control board is connected to sensors that determine if the door is in an open or locked position and if the locking mechanism is engaged or not engaged. The control also keeps track of which lockers are in use and which are available for storage and uses an alpha numeric system or equivalent to uniquely identify each particular locker. A signaling system for each locker, such as light emitting diodes, can be used where, for example, a red light would indicate a storage locker in use and a green light indicating one that is available for use. The signaling system can also provide for blinking of the lights to indicate that items have been placed therein and the door closed but that door has not been locked as payment has not yet been completed. To retrieve their items a user would need to re-swipe the same card used to rent the locker originally.

The card reader and electronic control can also be connected to a security system. The security system can be that of a preexisting security computer network at the facility such as an airport or shopping mall where the lockers are being used. The storage system herein can further include software that provides to security personnel on their existing system or on an added computer system, information about; the use or non-use status of each locker, the identity and location of each locker, the identity of the individual whose card was used to effect payment, the time and date storage was initiated and the current duration of such storage. Security personnel in this manner are able to see on a video display all such information. In an airport setting, security personnel would also be able to have an input of identity information of all individuals that have passed through security and would be able to cross check that identity information with the identity information provided by each storage locker. It would also be possible to cross check the locker credit card information by connection with databases containing other pertinent in formation, such as, that of lost or stolen credit cards, known felons, suspected terrorists, and the like.

In operation, a user would find an available locker and place their items therein and close the door. The signaling system would then use the blinking lights to indicate that the door is closed but not locked and that the user's card is now to be swiped in the card reader and authorized. Once the appropriate pin information is entered and payment made, the control board operates the locking mechanism to the locked position and the signaling system indicates the locked condition if a successful locking has been sensed to have occurred. Security personnel would then be provided by the software with the information about the time of use of a particular locker along with the credit card information.

The software would, at the time of storage, and periodically thereafter, initiate a cross checking with any available name/credit card databases. In this way it is possible to see if there is a match with lost or stolen cards, with names of convicted felons or criminals at large, and in the case of airports, with names of those that have passed through security and are properly in the gate area and with the names of those on any available “do not fly” lists. If, for example, a lost or stolen card is found, then the software can indicate that entry by a check mark, highlighting, colored indicator and/or audio sound to alert personnel of the problem so they can take the appropriate action. The software is also programmed to lock the contents of the locker with which the stolen or lost card was used so that re-use of that card will not permit retrieval of the locker contents. If remote video surveillance is possible of the locker in question, that can be initiated automatically by the software to begin video taping of the any individuals attempting to retrieve the locker contents. The software also has the ability to be programmed to indicate an “overtime” situation has occurred wherein a predetermined amount of time has lapsed within which the contents of the locker should typically have been retrieved. In the case of an airport, the software can also be set to cross check names of those “legitimately” using the locker as being cleared by security, with departure times of such individuals. Thus, if their flight has left yet their possessions remain behind, the software can identify such a situation.

The software also has the capacity to vary the degree of an alert. Thus, if a name on a “do not fly” list is indicated the alert color or highlighting could be red and/or a further unique audio signal used from that of a lower level concern, such as, a lost or stolen card or that of an overtime situation. Once so notified, it is of course strictly up to security and law enforcement personnel as to what constitutes the appropriate response. A “walk by” inspection of the contents can be effectuated in certain cases as the locker door is not opaque and permits a visual inspection of the locker contents.

One or multiple sensors can also be placed in the lockers that monitor for drugs, explosives or other contraband. Information provided by the sensors to the control is displayed to security personnel at a remote terminal.

### BRIEF DESCRIPTION OF THE FIGURES

A better understanding of the structure, function, operation and the objects and advantages of the present invention can be had by reference to the following detailed description which refers to the following figures, wherein:

FIG. 1 shows a perspective view of an embodiment of the present invention.

FIG. 2 shows a perspective view of the embodiment depicted in FIG. 1 with the door thereof in the open position.

FIG. 3. Shows an enlarged top plan partial cross-sectional view of the shelf of FIG. 2.

FIG. 4A shows an enlarged front plan partial cross-sectional view of the locking mechanism of the movable shelf.

FIG. 4B shows a cross-sectional view of the locking mechanism of the movable shelf along lines 4B of FIG. 4A.

FIG. 5 shows a schematic view of the electronic control of the present invention.

FIG. 6 shows a graphical user interface of the control system of the present invention.

FIG. 7 shows a further graphical user interface of the control system of the present invention.

FIG. 8 shows a flow diagram of the software control logic of the storage system of the present invention.

FIG. 9 shows a continuation of the flow diagram depicted in FIG. 8.

FIG. 10 show a perspective further embodiment of the storage unit of the present invention.

FIG. 11 shows a front plan view of a single embodiment of the storage unit of FIG. 11.

FIG. 12 shows a cross-sectional view along lines 12-12 of FIG. 11.

FIG. 13 shows a cross-sectional view of the sliding door of the embodiment depicted in FIG. 10

FIG. 14 shows a top plan view of the sliding door of the embodiment depicted in FIG. 10.

FIG. 15 shows an alternate embodiment of a door useable with the storage unit depicted in FIG. 10.

FIG. 16 show an alternate arrangement of the storage units depicted in FIG. 10.

FIG. 17 shows a perspective view of a further embodiment of the storage unit of the present invention.

FIG. 18 shows a front plan view of the embodiment of FIG. 17.

FIG. 19 shows a perspective view of a further embodiment of the storage unit of the present invention.

FIG. 20 shows an enlarged view of the locking mechanism of the embodiment depicted in FIG. 19

FIG. 21 shows a cross-sectional top plan view along lines 21-21 of FIG. 19.

FIG. 22 shows a cross-sectional top plan view along lines 22-22 of FIG. 19.

### DETAILED DESCRIPTION

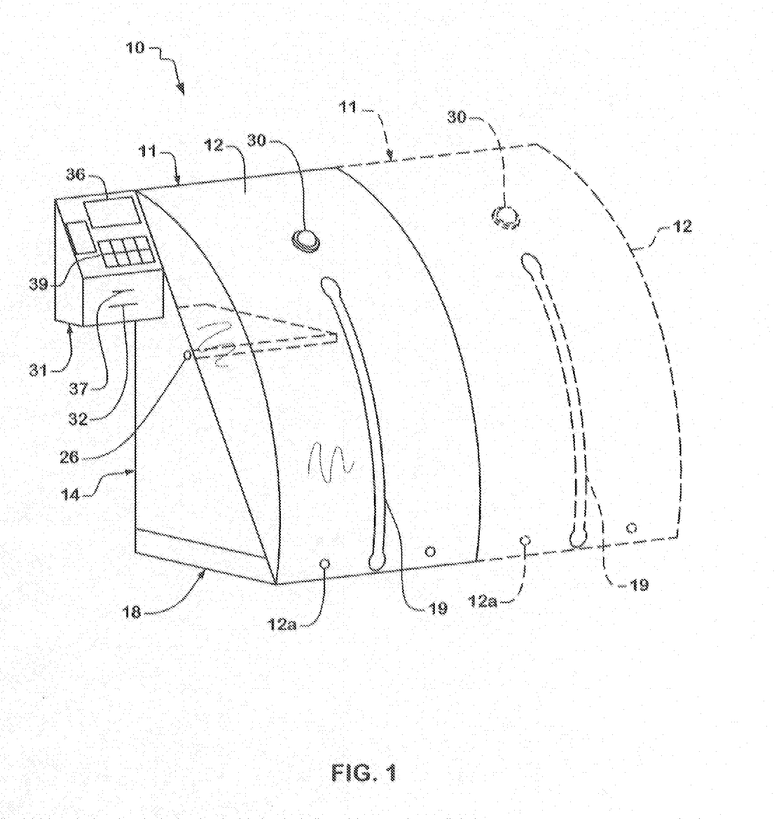

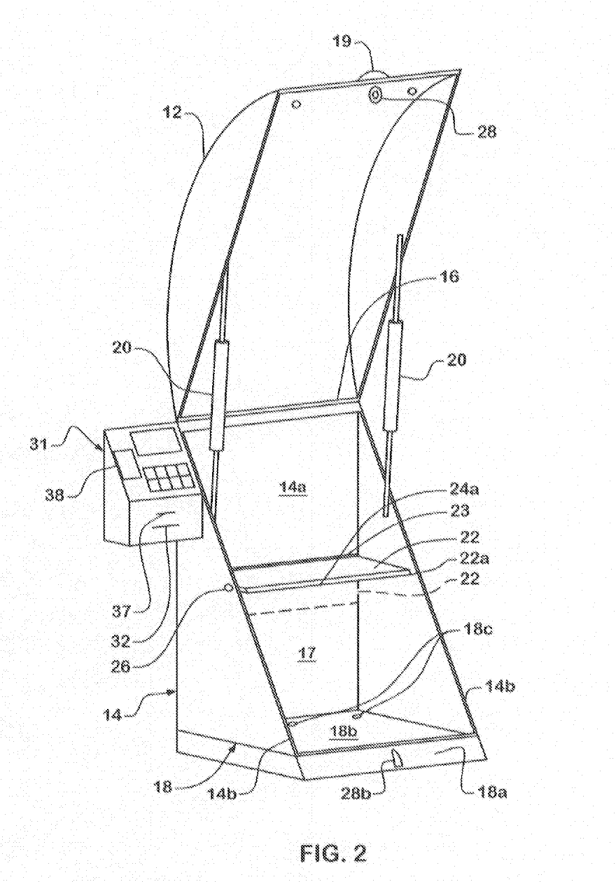

An embodiment of the storage system of the present invention is seen in FIGS. 1 and 2 and generally referred to by the numeral 10 and includes one or more storage units 11 arranged next to each other linearly and resting on a ground or floor surface. Each storage unit 11 includes a clamshell door 12 pivotally secured to a storage housing 14 by a hinge 16 for defining an article retaining or storage area 17. In this embodiment, door 12 has a convex shape to permit an increased interior storage area 17 when closed against housing 14 and can include one or more vent orifices 12a. For reasons described herein below, in one embodiment of the invention herein door 12 can be fully or at least partially transparent so that the articles placed in the retaining area can be seen when door 12 is in the closed position. Those of skill will appreciate that door 12 can be manufactured of a wide variety of materials that can provide for transparency as well as be sufficiently strong to resist breakage to keep the articles within the storage area 17 safe from tampering or theft by others. Such materials include, but are not limited to; various plastics such as, polyethylene, polypropylene, and polyvinylchloride. Forming thereof can be accomplished through a variety of techniques including blow or injection molding. Housing 14 can be made of a variety of materials including, sheet metal, as well as the aforementioned plastics.

Housing 14 is defined by a back wall 14a, side walls 14b and a bottom platform portion 18. Platform 18 includes a tapered edge 18a, an item supporting surface 18b spaced above the ground surface on which storage unit 11 rests and one or more vent orifices 18c. Door 12 is opened through the use of a door handle 19 and the opening thereof is assisted by pneumatic cylinders 20. Door handle 19 extends along door 12 from a bottom end thereof adjacent the floor surface and upward there from to a position adjacent a top end of storage unit 11. A further storage unit 11, as depicted in dashed outline and marked by the numeral 11′ can be positioned next to unit 11. Those of skill will appreciate that any number of such units 11 can positioned in a line alongside each other.

As seen by also referring to FIG. 2, an accessory shelf 22 is located in base unit 14 and is attached thereto by a hinge 23 to back wall 14a and between side walls 14b. Shelf 22 includes a spring loaded locking mechanism including two pins 24 retained in a rounded front shelf lip housing 22a. Pins 24 have manually operable ends 24a and also include a spring attachment washer portions 24b integral therewith as well as insertion ends 24c. A pair of springs 25 are positioned within housing 22a and positioned between and secured to washer ends 24b and to an interior portion of housing 22a. Springs 25 serve to bias pins 24a in a locked direction, as indicated by arrows L. When in the locked position, pins ends 24c are fully extended and are inserted into holes 26 of sidewalls 14b and serve to retain shelf 22 is in a horizontal or article holding position as shown in FIG. 2. To move shelf 22 flat against back wall 14a, as represented by the dashed lines 22′ thereof, a user operates pin ends 24a in the direction indicated by arrows W to withdraw ends 24c from holes 26. Shelf 22 can then be moved by the user in a downward direction against back wall 14a. To place shelf again in its horizontal position, a user can grasp shelf 22 and lift it to that position so as to register pin ends 24c with holes 26. When so aligned, springs 25 will cause ends 24c to automatically be reinserted into holes 26 thereby retaining shelf in its article supporting position.

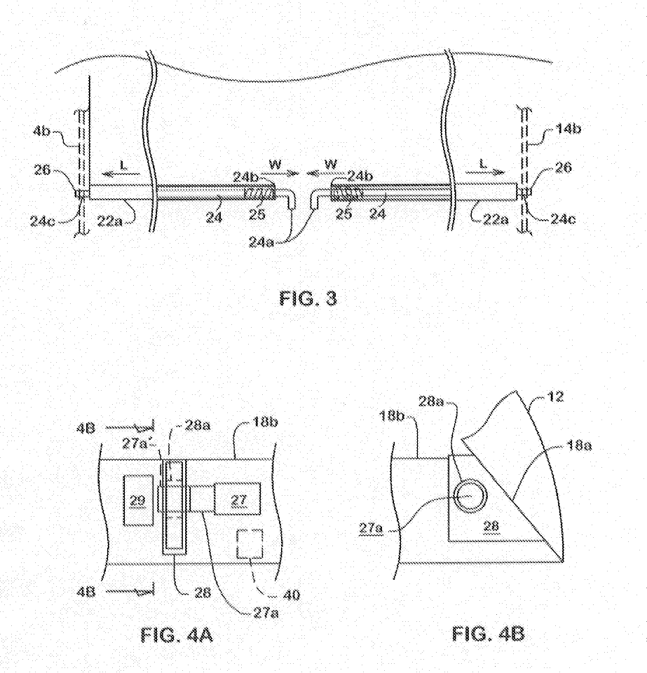

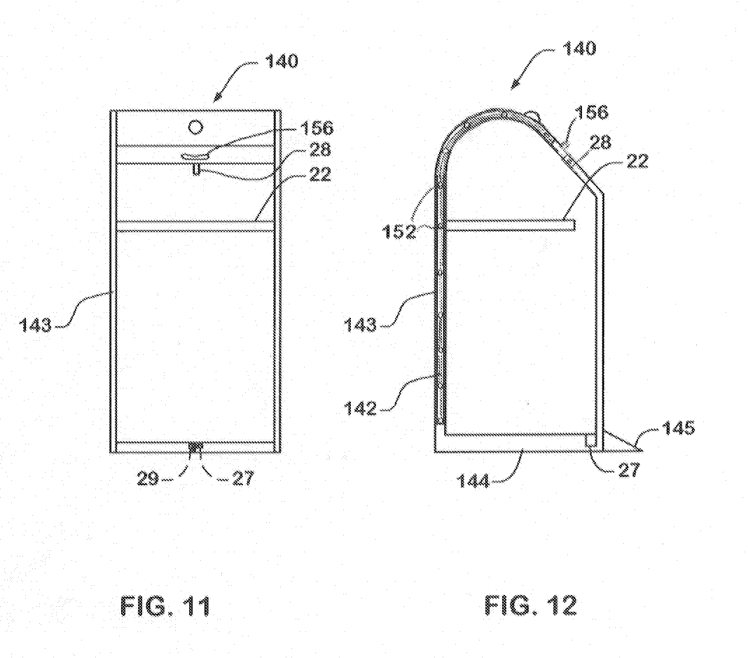

As seen by also referring to FIGS. 3A and 3B, retained within base 18 is a locking mechanism 27. Mechanism 27 can be of the well understood bi-stable solenoid type having a pin 27a. The retracted position of pin 27a is seen in FIG. 4A and the extended position thereof is indicated by a dashed outline identified by numeral 27a′. As is well understood, only a small amount of electrical energy is needed to move pin 27 between its two positions and once so moved no energy is consumed to maintain either position. Door 12 includes a locking flange 28 secured to and extending from a bottom end thereof and including a locking pin receiving orifice 28a. Flange 28 is sized to be inserted into a flange receiving hole 28b in base 18 as door 12 is moved to its closed position, as seen in FIG. 12. When in the closed position, hole 28a of flange 28 is positioned so that it is in register with locking pin 27a. Thus, operation of solenoid 27 to move pin 27a to its extended position results in pin 27a extending through hole 28 thereby locking door 12 in its closed position.

A door closed sensor 29 is positioned within base 18 and adjacent solenoid 27. Sensor 29 functions to sense whether or not door 28 is fully closed whereby flange hole 28a is in correct register with pin 27a for moving pin 27a into the extended locking position. Those of skill will appreciate that various sensing means are available such as both non-contact proximity sensors and contact switches.

An indicator light 30 is secured to each storage unit 11 to indicate visually the status thereof as to whether or not it is open and available for rental, closed and in use or in the process of being rented. In one embodiment, light 30 includes suitable lighting devices, not shown, such as incandescent or LED lights having the capacity to shine continuously, blink and/or display light of a plurality of colors, such as, green and red.

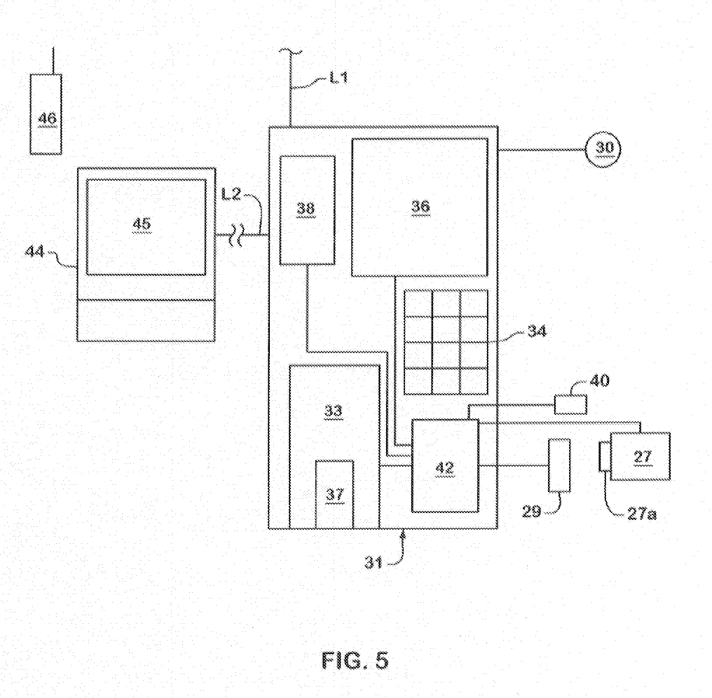

As understood by also referring to FIG. 5, the present invention includes a payment determining device such as a credit card reading device 31 for reading and accepting credit card payment having a credit card inserting or reading slot 32, a credit card reading mechanism 33, a data entry keypad 34, a video/touch screen 36, and a receipt printer 37. An embodiment of the present invention can also optionally include a biometric reading device 38 such as a fingerprint reader or retinal scanning and imaging device. Either such biometric device 38 is positioned adjacent card reader 31. The present invention can also optionally include a contraband sensor or sensors 40. Such sensors are used to detect the presence of conventional bomb chemicals, radiological materials or illegal drugs. Sensors 40 can be placed within each storage unit 11 or within base 18. In the latter case, holes 18c in base surface 18b provide for air flow to sensors 40 so that any molecular or radiological signatures emanating from contents stored within a container 11 can be detected. Where the cost of sensors 40 is high, it is also possible to have a fewer number or one of such sensors 40 within base 18 wherein base 18 is used as a plenum between a plurality of storage units 11. Thus, it would be possible for one such sensor 40 to be used for a plurality of storage units 11. Door holes 12c can serve to facilitate airflow to sensors 40 and improve the detection ability thereof. Holes 12c can also serve to enhance the detection ability externally of storage units 11 in the case where security personnel use handheld electronic sensors or contraband sensing dogs. The invention herein also includes a microprocessor based control board 42 to which one or more solenoids 27, proximity sensors 29, indicator lights 30, card readers 31, biometric sensors 38, and contraband sensors 40 are connected. Control board 42 is supplied power along line L1 and also includes LAN connection line L2 to a remote security terminal or computer 44 having a video display 45. Terminal 44 and/or control 42 can include a WiFi or similar capability for wireless communication with a portable handheld device 46.

In operation, it can be understood that a user having various articles that they would like to store safely can see by the indicator light 30 whether or not a particular storage unit 11 is available or in use. Light 30 can be green to indicate availability and red to indicate an in use condition. In the case where door 12 is transparent, it will also be immediately known at a closer range if the locker is available or not. Credit card reading mechanism 31 must then be operated to read the user's credit card. In the embodiment shown, the credit card is inserted partially into slot 32 whereupon the reader mechanically draws the card therein. After receiving approval, the user is prompted to use keypad 34 to enter in the unique identifier for the locker they have selected, e.g. 12H. The identifier is simply an alpha and/or numeric sequence that uniquely identifies the particular storage unit, which sequence is printed on a tag prominently displayed on each storage unit 11. After approval, reader 31 then ejects the user's credit card and signals lock 27 to operate to the unlocked position so the user can then grab handle 19 and lift door 12 to its fully open position. At the same time control board causes light 30 to blink further identifying the correct locker for the transaction at hand and to indicate that such locker is in the process of being rented. In the present example if the light 30 was showing a constant green to indicate availability the light produced would now be an intermittent or blinking green.

The force required to open door 12 is reduced by the pneumatic cylinders 20 which automatically move door 12 to its fully up position seen in FIG. 2. It can be appreciated that the length of handle 19 also assists in opening door 12 as the user is not required to bend over very much to initiate opening of door 12. It can further be appreciated that as handle 19 extends to a bottom end of door 12 the user can also easily continue to grasp and control door 12 as it moves to its fully open position as well as to grasp and move door 12 to its closed position.

The user can then place their valuables in housing area 17. In the case of wheeled luggage it can be appreciated that tapered edge 18a facilitates the rolling thereof into storage area 17. Of course, the size of the storage area 17 is purely a matter of design choice and is dependant upon the size of the articles that would typically be stored by the user. For example, in the case of an airport application the standard carry on luggage along with other user items such as a purse, laptop computer and any outer garments may require an overall height of a storage unit 11 to be in the rang of 40 inches with a width of approximately 24 inches and a depth of 16 inches. Accessory shelf 22 provides for storage of such things as a notebook computer, purse, hat and gloves, etc. and is movable to a down position, as previously described, against back wall 14a to increase the unobstructed size or storage area 17 to facilitate storage of a large item.

Once the user has placed their items within storage unit 11 they can return door 12 to the fully closed position. Sensors 29 determine when door 12 is in its fully closed position after which controller 42 operates lock 27 to operate pin 27a to its locking or extended position again retaining door 12 in its closed position. Light 30 can then be changed to continuously show a different color, e.g. red, to indicate the in-use status of the particular storage unit 11. Receipt printing mechanism 37 of card reader 31 then prints out a receipt indicating the start time of the rental and identifying the locker rented by its alphanumeric sequence, e.g. 12H in the present example. This receipt is then retained by the user to assist them in knowing when their rental period began and in knowing which locker they rented.

When the user desires to retrieve their valuables, they simply re-insert the same credit card they used to initiate the rental transaction into card reader 31. Control board 42 retains the credit card information and then unlocks the appropriate locker upon receiving that correct credit card information. Light 30 can again blink, e.g. red, to indicate that the particular storage unit 11 is in the process of being emptied of its stored contents. Screen 36 then indicates to the user that door 12 must again be closed prior to ending of the rental period. The user must then return door 12 to its fully closed position whereupon sensor 29 signals to control board 42 to activate lock 27 to the locking position, to change light 30 status to continuous, e.g. green, indicating in this example the storage unit available status and to permit the printing of the final receipt and return of the credit card.

Those of skill will appreciate that a wide range of various card reading systems exist where the card is inserted, inserted and quickly manually withdrawn, or swiped and any such are appropriate and a matter of design choice. However, in cases where it is necessary that the locker door be re-closed and locked, a card reader which includes a mechanism for pulling the card therein and subsequently ejecting the card following a successful transaction may be preferable to ensure user compliance. In many cases it may not be necessary that door 12 be re-closed as cylinders 20 maintain door 12 in the open position and that can be used as a visual cue as to availability in lieu of light 30. Moreover, controller 30 can leave lock 27 in its unlocked position so any closing of door 12 would not cause damage as a result of interference between locking flange 28 or lock pin 27a. Additionally, it would not be possible for a user to simply place their items in a storage unit 11 and attempt to close door 12 without paying a rental fee as door 12 would always move back to its fully open position. Those of skill will understand that it is generally desirable from a cost point of view to have a credit card reader and control board associated with and serving a plurality of lockers rather than having one of each per locker. Thus, the various lockers would be multiplexed with the reader in order to achieve this operational efficiency. It is also contemplated that the present invention could take advantage of other systems that may not require the physical interaction with a credit card or the like. For example, electronic credit cards or other similar devices have been proposed that include the information of the type stored on the magnetic strip of a conventional credit card. Such an electronic card, when in close proximity to a suitable reader/receiver and when initiated by the user, transmits that information wirelessly thereto, such as by a blue tooth or infra-red signal or the like.

In most cases the storage charge will not be a pre-set of fixed amount, but is based on time of use. However, it is contemplated that the storage rental fee will be a small amount and not require a signature by the user per se, however to the extent that might be required, reader 31 could include an electronic signature touch pad typically integrated with video display 36.

In conjunction with a credit card reader or in substitution thereof when combined with a cash acceptance mechanism, it is also possible to use a further biometric identification means 38, such as a fingerprint reader or retinal scan imager. Use of such additional identification devices can serve to make the overall system more secure as there would then be a greater certainty that the person storing the items and retrieving them are one and the same. In the case where a fingerprint scanner is used, after inserting their card to initiate a rental transaction, the user would then be requested on the video screen to place a finger, typically the forefinger of their right or left hand, on a reading surface thereof. Once the reader has made a successful scan and saved that information, locker mechanism 27 would operate to release door 12 and light 30 would indicate that the particular storage unit is in the initiating storage mode. The process would continue as previously described where the user places their valuables in the locker and returns door 12 to the fully closed position. After door 12 is then re-locked the user is provided with a receipt and light 30 signals the in-use or unavailable for rental mode. When the user desires to retrieve their items they would need to first insert the same credit card they used previously to store their items. Following approval they would be prompted on screen 36 to place the same finger they had scanned previously onto the fingerprint reading pad. The scan thereof would then be compared with the stored previous scan information and if a positive match is determined to exist, lock mechanism 27 would be operated to release door 12 and light 30 would then indicate the removal of contents mode. The user would be prompted on video screen 36 to retrieve their items and to return door 12 to its fully closed position. Once the user complies, light 30 would change to indicate the storage unit availability mode, and the user's credit card charged for the rental period amount after which their credit card is returned and a final receipt printed.

The storage system herein has applicability in a wide range of venues, including, airports, shopping malls, amusement parks and the like. When a high level of security is required, the present invention permits security personnel to track the use thereof through a remote terminal or computer 44. A further inventive aspect of the present invention comprises software used to provide security personnel with information about the use of storage units 11. Requiring the use of a credit card for payment rather than cash makes the transaction much less anonymous. Thus, the software allows the user's identity information on the credit card to be checked against any available databases. Such databases, particularly in airport settings, can include information about those individuals that are flying that day and/or that have passed through security, their particular flight information, such as, their flight carrier and flight number, times of arrival and departure and the like, as well as information about stolen cards, persons on any “do not fly” lists, or other lists of criminals at large such as persons that have violated parole, and the like.

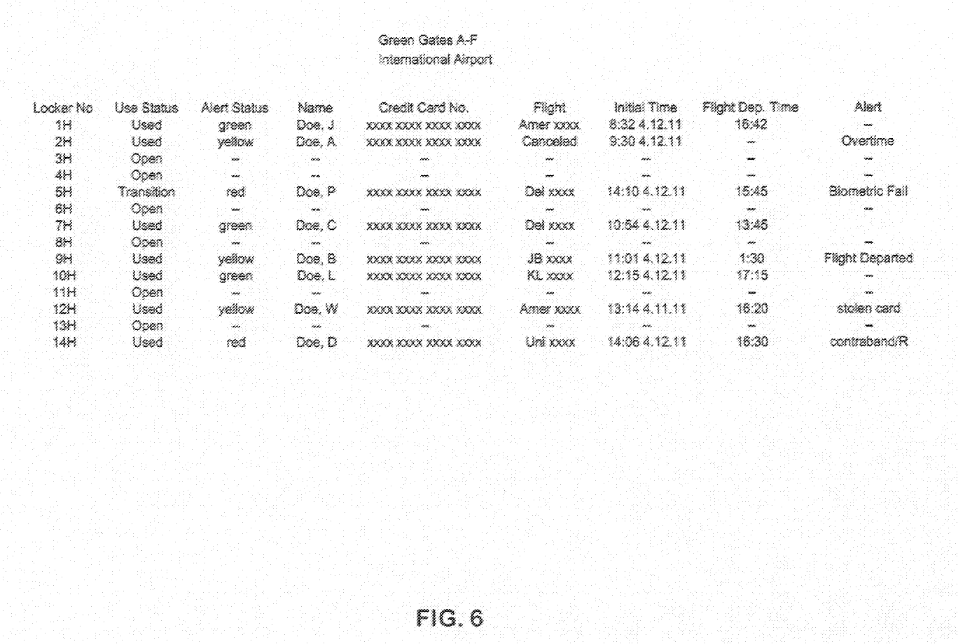

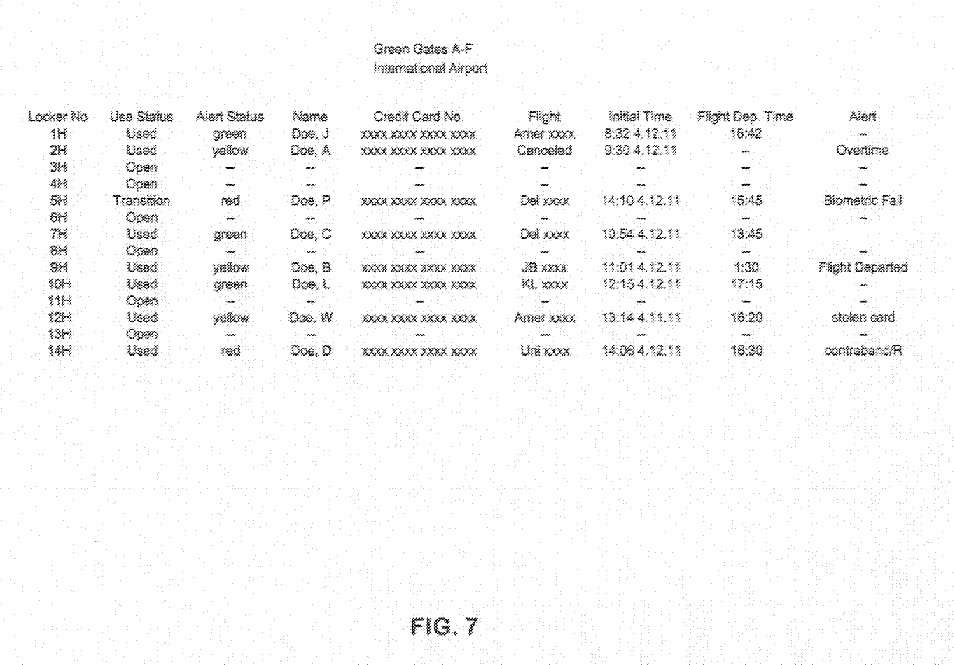

As seen by referring to a FIG. 6, security personnel are presented with a graphical user interface screen on display 45 that clearly shows all relevant information regarding the use of the storage units 11, such as, the unique sequence identifier thereof, which are in use or not, the time storage was initiated, the alert status and the reason for the alert. By clicking on any of the locker numbers a second screen, as seen for example in FIG. 7, can be brought up showing further information such as the credit card information, including card number, card owner, as well as flight, and flight departure time. Clearly, additional screens can be created where, for example, by clicking on the credit cards owner's name further particulars including their address and other contact information can be listed. The user information is then compared by the software with any other available database information to determine, for example, if that user is legitimately in the airport gate area and/or if the credit card is lost or stolen.

It can be understood in the example data seen in FIGS. 6 and 7 that the least level of concern is shown by a green alert level, with yellow showing a moderate alert level and red showing the highest alert concern level. As seen in those examples, unit 2H is set at yellow alert status as an overtime situation has occurred. The software is user configurable for the period of time that will be considered unusually lengthy and deserving of attention. In the present case the overtime limit is set at six hours. In the example of storage unit 2H that time has been exceeded and there exists a further concern due to the cancelled flight status. However, in the case of storage unit 1H, even though it can be seen that the overtime limit has been exceeded, the user's flight has not yet departed. The software can thus be set to ignore exceeding of the overtime limit if the departure time has not yet arrived. Locker 5H is in a red alert status as that storage locker is in transition, and in this case, the contents thereof are trying to be removed, however a biometric sensor 38 is signaling a failure in matching the first biometric scan to the second. This could be a malfunction but could also indicate an attempt to defeat such security measures. Thus, the system automatically alerts security through their remote terminal interface screen and overrides any attempt by the user to open the locker and retrieve their items. For locker 7H we have a green alert status where the overtime has not been exceeded, the flight has not yet left and where no other biometric fail or matching of the card owner name with an unauthorized name or card has occurred. Locker 9H shows a yellow alert status in the example where the overtime has not been exceeded but where the user's flight has departed. Locker 12H demonstrates the situation where the software has found a match between the card used and that of a stolen card and has indicated a yellow alert status. Unit 14H shows a situation where a contraband sensor 40 has sensed contraband, in this case a radiological signal, and has created a red alert status. Those of skill will understand that various alert levels can be created in addition to the three shown above and that the software can be configurable by the user to adjust the severity of the alert level of a certain detected event to fit their particular needs. The software can indicate through color and/or sound at the terminal 44 and display 45 and/or handheld device 46 different levels of alert to the security personnel. Security personnel can then take whatever measures they deem appropriate for the situation, including a walk by of the storage unit in question, video surveillance and/or notification of the appropriate authorities. In practice, the software would typically highlight an information line or parts thereof with the appropriate alert color to facilitate quick notice of an alert issue.

The security authorities have the capability with their terminal 44 to communicate with and control the operation of controller 42 through the LAN line connection L1. Whereas, the software can be configured to automatically lock down a particular storage unit when, for example, contraband is sensed or for any event determined to be at a top alert level, there may be lesser levels of concern where the system does not automatically go into a lock down mode and prevent the user from retrieving their items. Thus, for example, if for any reason security deems it necessary to do so, they can override the normal operation of the system and lock down any particular locker. Security can also override the operation of controller and unlock a storage unit 11 at any time as may be required by their security protocol to check the items stored therein even though the automatic system has detected no problems. \

Opening of a locker would require certain procedures be followed. It could be done remotely at the security terminal 44 or by an appropriate handheld device or by security operation of the card reader associated with the unit in question. Security personnel would have to key in with the terminal, handheld device or with the card reader an appropriate security code uniquely identifying the security personnel entering the code as well as any further code. Clearly, any such code would need to be changed on a periodic basis.

If a user's identity information can be accessed quickly after the time the user has inserted their credit cart but prior to their card being ejected and returned, card reader 31 can be signaled to retain that card. The software then alerts security, through for example, an on screen red highlighting on terminal 44 identifying the locker in question and an automatic sending of a voice and/or data message wirelessly, telephonically and/or over a LAN network to appropriate security and law enforcement personnel identifying the locker in question and the nature of the problem. Card reader would retain the card and would simply indicate to the user via the video screen 36 that there was a problem authorizing the card and provide a number for the user to call for assistance. Card reader 31 includes a locked access panel, not shown, that permits security personnel to retrieve cards retained thereby.

In cases where such rapid identification can not be attained in a “real time” manner during the initial rental process, that is, after the user's card is first inserted but prior to authorization, locking of the storage unit and return of the card to the user, such information would necessarily have to be compared with database information subsequent thereto. It is probable that most available identity database information, such as lists of names or stolen credit card numbers can be compared with the credit card data very rapidly. However, in the case of biometric data, such as a fingerprint or retinal scan, comparison thereof with law enforcement databases can take significant time. Therefore, that information may of necessity be retrieved and compared after the user's items have been stored but before the user returns to retrieve them. In either case, immediately after the system detects a security problem it will automatically notify security personnel at a remote security terminal and will be programmed to withhold the card either at the initiation of the rental process or at the end thereof when the user attempts to affect retrieval of their items. In both instances, the system visually and/or audibly alerts security personnel at the remote terminal. Those of skill will appreciate that there may be a plurality of remote terminals and that many such “terminals” may in fact be wireless handheld devices.

Overtime alerts can be programmed where a predetermined period of time is considered longer than the typical rental time that would be expected under the particular circumstances. For example, an overtime alert would be particularly important where, as previously stated, the user's flight information indicates their flight has departed but their items remain in a storage locker. The system can also be programmed to look for unusually long rental periods. A long storage period may be suspicious where the user's flight has been canceled and no further flight booked. A long storage period may also be suspect where the user has flown to the airport and the airport is their final destination or where they have not booked a further flight. It would be expected in either case that any rental would be for a relatively short period of time.

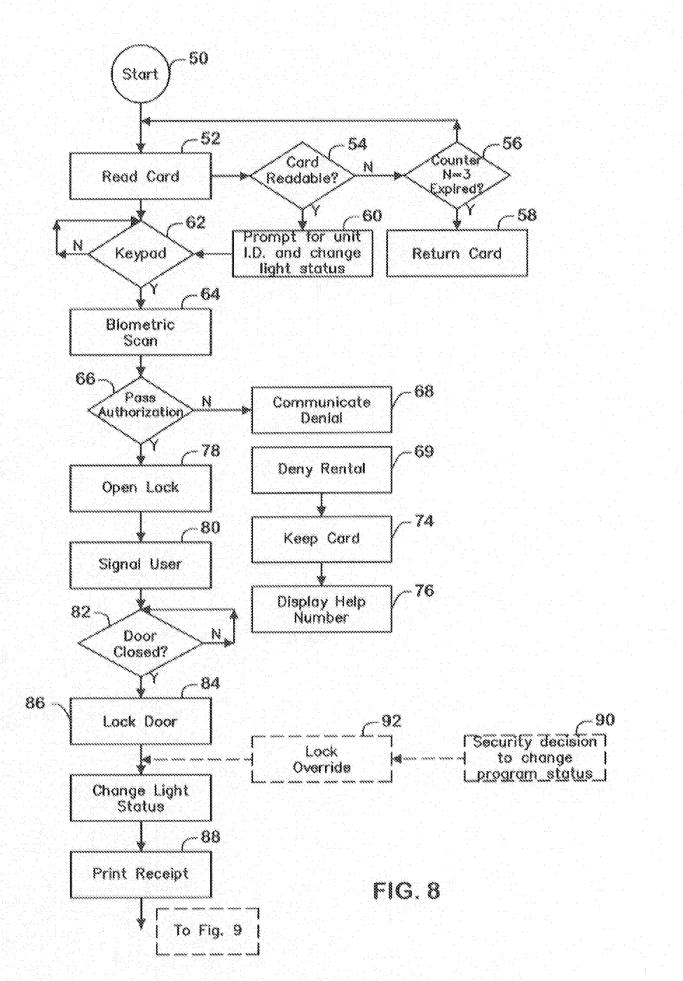

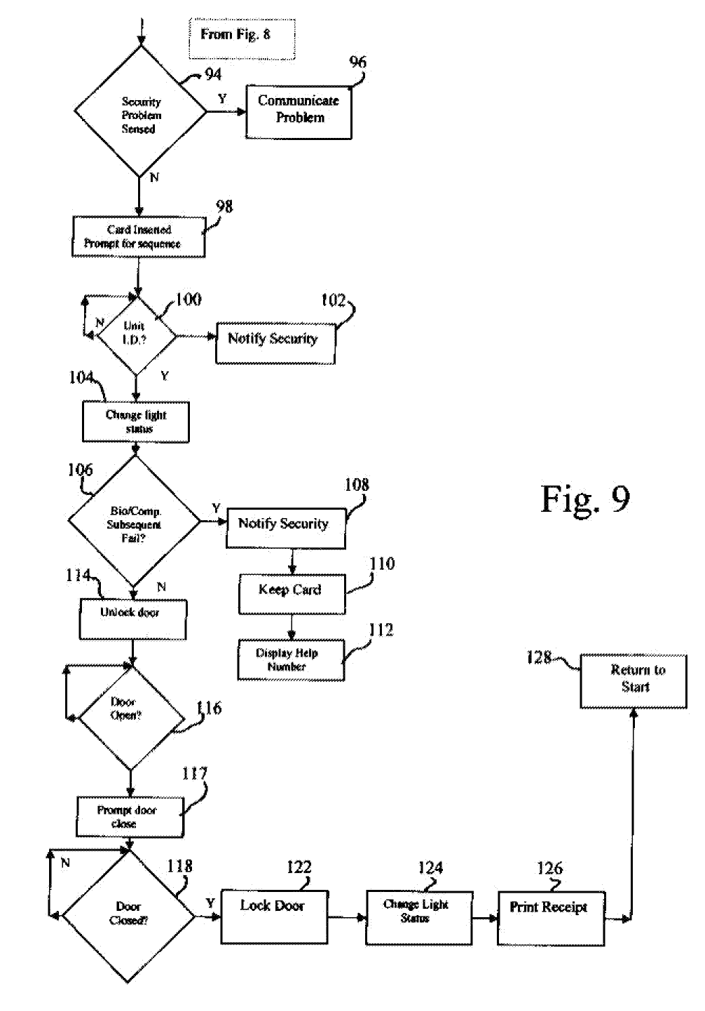

As seen in FIGS. 8 and 9, a flow diagram of the software control logic of the present invention is shown. At start point 50 the controller/software is waiting for a storage unit rental transaction to occur. At block 52 a card is inserted into reader 31 and at block 54 it is determined if the card is readable. Block 56 is a counter that permits three tries to read the card where if unsuccessful the card is returned to the user. If the counter counts out then the card is returned to the user at block 58. However, if the card is readable, then at block 60 the user is prompted by video screen 36 to use keypad 34 to enter the unique storage unit sequence identifier and the light status is changed to indicate an in-use initiation of rental status. At block 62 the software awaits the entering of a correct storage unit identifier. Those of skill will appreciate that the software can display on screen the storage unit identifier entered and prompt for entry of another if an incorrect one is entered or if one of a locker in use is entered. It is also possible for the software at this point to prompt the user as to whether or not they want to rent more than one unit and, if so, to enter those additional identifiers and to change the light status to in use on any additional storage units as well. If a biometric scan is used then the software at block 64 prompts for that and walks the user through the scan process. Upon completion of a successful scan the software at block 66 conducts any and all authorization tests that are possible at that time. Thus, in addition to checking for card validity and available balance, the user's name can be compared with any name database to check for any reason that rental should be denied. If a problem arises, at block 68 a notice of denial is sent to security personnel at, for example, terminal 44, and or to a portable wireless device 46. At block 69 the rental process is stopped and unlocking of the unit denied and at blocks 74 and 76 respectively, the card is kept and a help display is given to the user. Those of skill will understand that in certain situations the sequence of blocks 68 through 76 can be altered depending upon the nature of the authorization fail. Thus, if the card is a stolen card, then that sequence of steps can be used as the goal is to remove that card from the user's hands. If video surveillance tapes of that storage unit are available then security will have an additional means of apprehending the perpetrator. However, where the fail is as a result of the user's name showing up on a suspected terrorist list or another known or suspected criminal list, security may want to do more than merely confiscate a credit card. Thus, the software herein can be user configured in such cases to permit the continuation of the rental process to block 78 where mechanism 27 is operated to open door 12 and permit storage of items therein. In other words, if the person is transporting some contraband, and especially if it is some type of weapon, it is far better to have it sequestered in a locked storage unit where the perpetrator can no longer gain access to it rather than to tip off that individual that he or she may have been identified. It would not be at all desirable to allow that individual to take a weapon or other contraband with them. As with a stolen card, the perpetrator may also not be tipped off by an immediate confiscation of the card so that when they come back to retrieve their items they can be questioned and possibly taken into custody.

If rental is allowed, then at block 80 the user is prompted to close the door and at block 82 the software determines by activation of sensor 29 if the door has been closed and in position so that at block 84 locking mechanism 27 can be operated to lock the door once again. Once the door is locked the light is signaled at block 86 to indicate an in use status and a receipt is printed at block 88 showing the time of rental and the unit rented. Blocks 90 and 92 serve to indicate that the software permits security to make a decision to override the system at any point to keep any particular storage unit in the locked state and not permit retrieval of the contents by the user or to open the storage unit to permit access to the contents by security personnel.

As seen in FIG. 9, the software flow diagram continues at block 94 where if a security problem is detected subsequent to the initial rental but prior to any attempt to retrieve the stored items security is alerted at block 96 so they can take appropriate action. When the user returns to retrieve their possessions they insert their card at block 98 and are prompted for the storage unit sequence or sequences. If the card is read and matched to a previously used card, which card has in the interim has identified a suspicious situation, security will be notified at block 102. The program will also alert security at block 102 if the card has previously been determined to be one that raises a suspicion and the user's card could be kept at that time and a help number displayed to the user on the card reader screen. At block 104 the light status is change to indicate a transition item removal state. If a biometric test was previously applied then at block 106 the user would be asked to retake that test as previously done so that a match can be verified or not. Any other database comparison can be run again if required. Thus, if there is a fail for any reason, then at block 108 security is notified, the card is kept at block 110 and a help number message is displayed at block 112. If the user is cleared to remove their items, then at block 116 it is determined that the door has been opened by un-making of proximity sensor 29. If that opening is sensed then at block 117 the user is prompted to re-close the door upon removal of their items from the storage unit or units. Once the system determines that the door has been re-closed, the door is again locked at block 122, the light status is changed to that of not in use, a final receipt is printed at block 16, and at block 128 the system for that storage unit is returned to the start position.

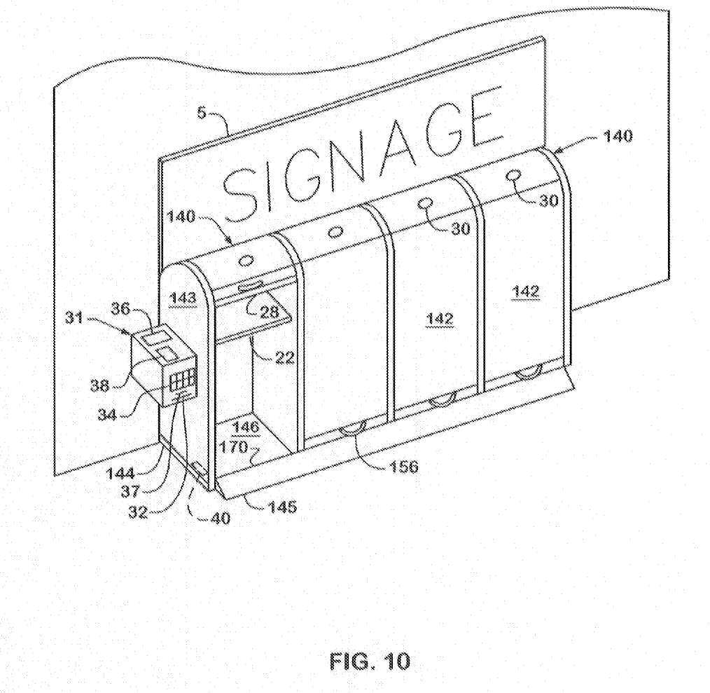

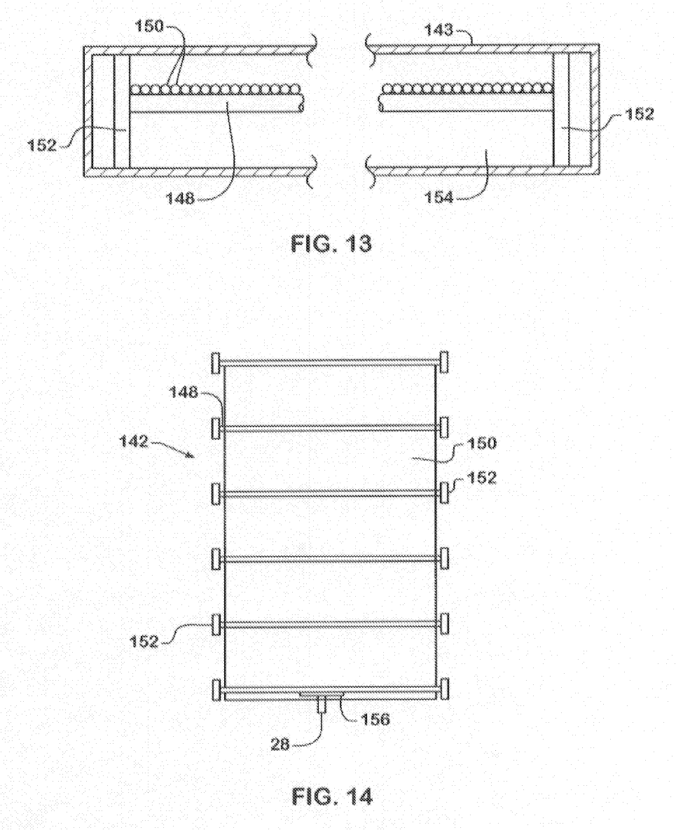

A further storage unit embodiment 140 of the present invention is seen by referring to FIGS. 10-16. As seen therein a storage unit 140 includes a sliding door 142, a housing 143 and a base portion 144 that together with door 142 defining an interior storage area 146. Base portion 144 also includes an inclined plane front edge 145. Door 142 includes a plurality of rods 148 to which are secured a plurality of flexible wires 150. Wires 50 can be made of metal such as steel or of plastic such as nylon. Each end of rods 148 includes a wheel or friction reducing guide 152 pivotally or rigidly secured thereto which guides travel in a cavity 154 formed within housing 143. Door 142 further includes an operating handle 156 and a locking flange 28.

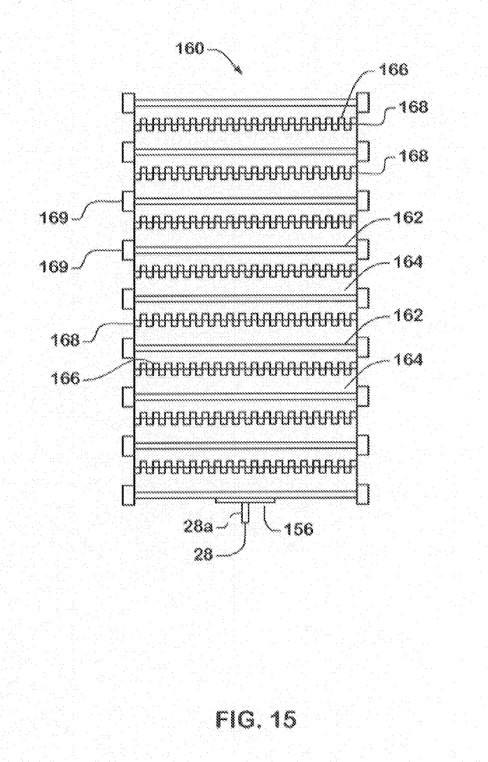

A further embodiment of door 142 is seen in FIG. 15 and identified by the numeral 160. Door 160 includes a plurality of rods 162 to which a plurality of flat rectangular panels 164 are pivotally or rigidly secured thereto. Each panel 164 is pivotally secured to its adjacent panel 164 through a plurality of hinge eyes 166 formed therein and through which a hinge rod 168 extends. Alternatively, each panel can be pivotally secured to each other by a live hinge consisting of a strip of flexible plastic or rubber adhesively secured along and between the interface of each panel 164 with its adjacent panel or panels 164. Each door 160 also includes wheels or friction reducing guides 169 secured to the ends of rods 162 as well as a door handle 156 and a locking flange 28 in the same manner as door 142. Door 160 will be understood to travel within cavity 154 in the same manner as door 142. Panels 164 can be constructed of any sheet material as is appropriate for the application such as of metal or plastic. However, where it is important that the contents retained within storage unit 140 panels 164 can be made of a high impact clear plastic. Door 160 further includes an operating handle 156 and a locking flange 28.

Those of skill will understand that storage unit 140 can also include a locking mechanism 27, proximity sensor 29, a light 30, a card reader 31, a biometric sensor 38 and a contraband sensor 40 as hereinabove described for storage unit 11. Thus, unit 140 operates in essentially the same manner as with respect to the method of operation of the present invention as hereinabove described for storage unit 11. The essential difference being the manner of operation of doors 142 or 160 which slide within cavity 154 and open and close in the manner of a roll-top desk door mechanism. Thus, a user can grab handle 156 thereof and lift to open storage unit 140 where the door thereof moves into cavity 154 to the fully open position depicted in FIG. 12. Flange 28 operates in the same manner as described above and as depicted in FIGS. 4A and 4B to be inserted into an opening 170 so that in a closed position of doors 142 or 160 they can be held closed by locking mechanism 27.

A further embodiment of the present invention is seen in FIG. 16 which shows a “kiosk” configuration wherein a plurality of storage unit embodiments as described herein can be arranged in a circular manner and be free standing in a floor area.

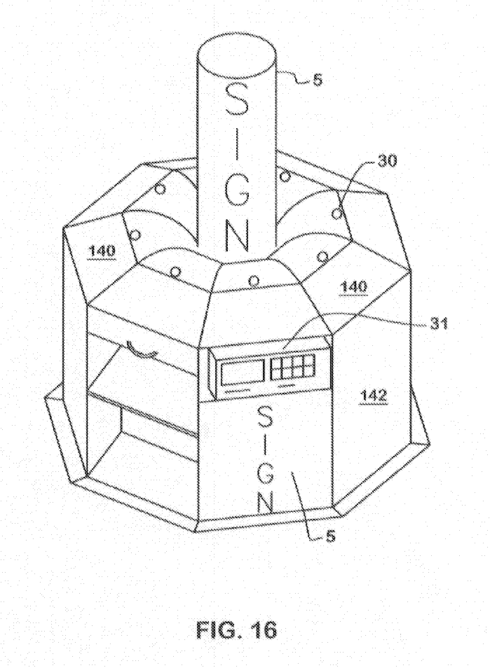

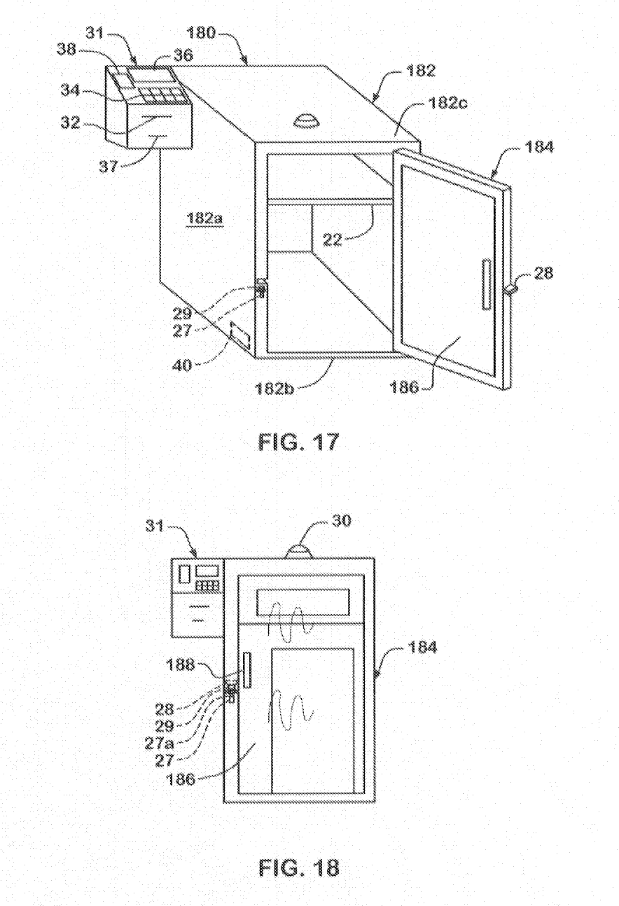

FIGS. 17 and 18 show a further embodiment 180 of the storage unit of the present invention. Storage units 180 include a rectangular housing 182 having sidewalls 182a, a base 182b, and a top end 182c. A door 184 is hingedly secured to a sidewall 182a and can include a clear plastic panel 186 as well as a handle 188 and a locking flange 28. Flange 28 provides for locking of door 182 through the use of locking mechanism 27. Embodiment 180 can also includes a proximity sensor 29, a light 30, a card reader 31, a biometric sensor 38 and a contraband sensor 40 and operate in the same manner as for the method described hereinabove for storage unit 11. Of course, door 184 operates to simply swing in a conventional manner between an open position seen in FIG. 17 and a closed position seen in FIG. 18. Storage units 180 lend themselves to be stackable one on top of the other and/or adjacent each other. If a unit 180 is positioned on a floor surface base portion 182b can consist of a single flat panel or no panel, or to the extent base 182 has some thickness or height can include a angled front surface for facilitating placement therein of wheeled items.

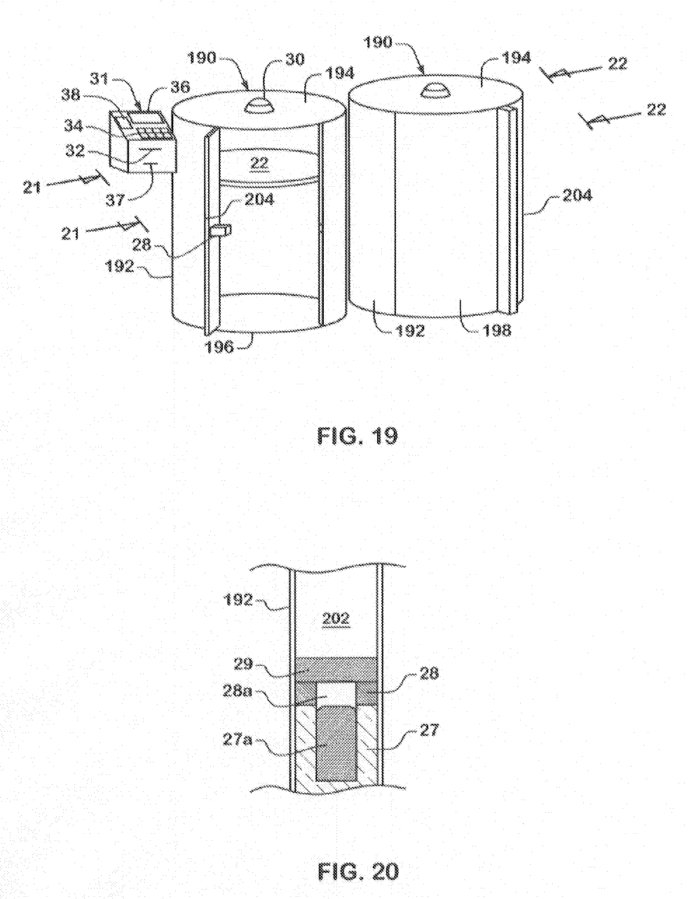

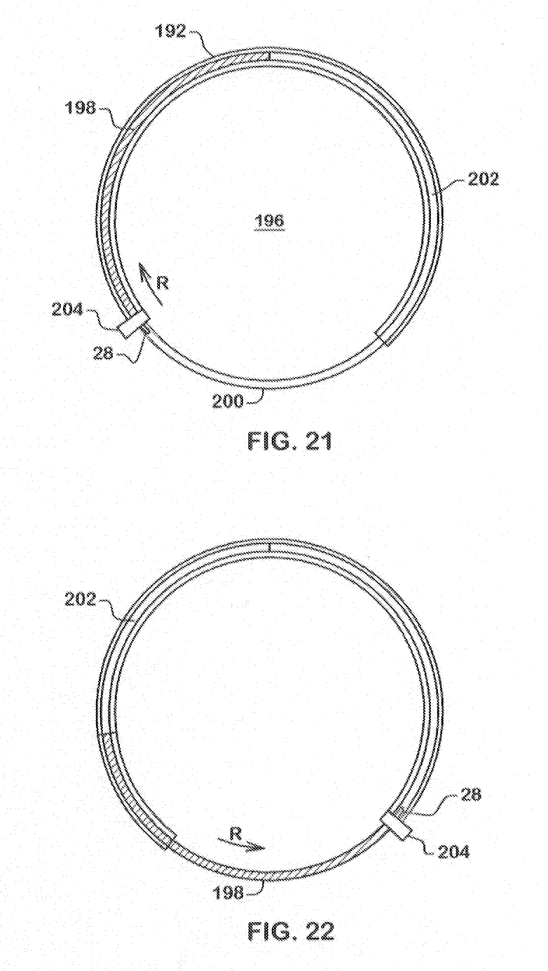

A further storage unit embodiment 190 of the present invention is seen by referring to FIGS. 19-22. Storage units 190 include a cylindrical or oval housing portion 192, a top end 194, a bottom end 196 and a sliding door 198. Door 198 closely matches the curvature of housing 192 to permit movement thereof as indicated by arrows R. Specifically, door 198 slides along on a track 200 formed in bottom end 196 and located within a cavity 202 formed in housing portion 192 between an open position and a closed position. The open position of door 198 is depicted in FIG. 21 and the closed position in FIG. 22. Door 198 includes an elongate handle 204 formed therein as well as a locking flange 28. As seen in FIG. 20, when flange 28 is inserted into slot 204 it interacts in the manner above described with a lock mechanism 27 where a pin 27a is insertable therein to provide for locking of door 198.

In this embodiment it can be seen that lock mechanism 27 is positioned within cavity 202 as is a proximity sensor 28. As with all the storage unit embodiments previously described herein, storage unit 190 can also include a proximity sensor 29, card reader 31, a biometric sensor 38 and a contraband sensor 40 and operate in the same manner as for the method described hereinabove for storage unit 11. Those of skill will appreciate that a plurality of storage units 190 can be positioned alongside each other and/or stacked on top of each other. It can also be understood that embodiment 190 lends itself particularly well to be made essentially entirely of plastic materials, such as, polyethylene, polypropylene or polyvinyl chloride and to be manufactured relatively inexpensively through blow or injection molding.

In all the above described embodiments it will also be apparent that advertising indicia or signage S can be placed on various surfaces thereof or on surfaces adjacent thereto and/or attached thereto and extending there from.

Those of skill will understand that here are many materials, configurations thereof and methods of manufacture thereof that can be used in constructing the invention that will be clear to those skilled in the art. Moreover, many modifications or changes can be made to the invention disclosed herein without exceeding the spirit and scope of the claims thereof as set out below.

1. A storage unit for storage of ankles therein by a user, including:
a housing having a bottom end defining an article retaining surface, the bottom end for placement on a ground surface and having a rear wall and side walls integral therewith and extending upward therefrom to a top edge end, the bottom end and having a front edge sized to facilitate placement by a user of an article from the ground surface onto the article retaining surface,
a door moveably secured to the housing and movable between a closed position and a fully open position, and when in the closed position the door defining together with the housing an outer otter surface area defining an enclosed article storage area and when in the closed position the door having a first surface area thereof comprising a portion of the outer perimeter surface area extending above the bottom end article retaining surface and when moved to the fully open position the door first surface area being moved away from its position above the article retaining surface to facilitate placement by the user of the article thereon,
a locking mechanism for securing the dour to the housing.

2. The storage unit as defined in claim 1 and the dour pivotally secured to the housing top edge end along a top generally horizontal edge portion thereof and the door having a bottom edge substantially coextensive with the bottom end front edge when the door is in the closed position.

3. The storage unit as defined in claim 1 and the door slideably engaged with the housing and the door having a bottom edge substantially coextensive with the bottom end front when the door is in the closed position.

4-6. (canceled)

7. The storage unit as defined in claim 1 and the door being sufficiently transparent to permit viewing of articles in the enclosed article storage area when the door is in the closed position.

8. The storage unit as defined in claim 2 and the door being sufficiently transparent to permit viewing of an article in the enclosed article storage area when the door is in the closed position.

9-15. (canceled)

16. The storage unit as defined in claim 3 and the door being sufficiently transparent to permit viewing of articles in the storage are when the door is in the closed position.

17-20. (canceled)

21. A storage unit for storage of articles therein by a user, including:
a housing having a bottom end for placement on a ground surface and side walls and an end wall integral therewith and extending upward therefrom to a top end edge, the bottom end defining an article retaining surface and having a front edge sized to facilitate the sliding or rolling thereon of an article by the user front the ground surface unto the article retaining surface,
a door having a first end pivotally secured to the housing top end along a substantially horizontal rear edge portion of the housing top end edge and the dour having a second end substantially coextensive with the bottom end front edge when the door is in the closed position so that the door can be liked upward by the user to a fully open position, and when in the closed position the door defining together with the housing an outer perimeter surface area defining an enclosed article storage area and when in the closed position the dour having a first surface area thereof comprising a portion of the outer perimeter surface area extending above the bottom end article retaining surface and when moved to the fully open position the door first surface area being moved away from its position above the article retaining surface to facilitate placement by the user of the article thereon.
a user operable locking mechanism for securing the door to the housing and preventing access to the article storage area by individuals other than the user.

22. The storage unit as defined in claim 20 and the door being sufficiently transparent to permit viewing of an article in the enclosed article storage area when the door is in the closed position.

23. The storage unit as defined in claim 20 and the door having a handle secured thereto and extending there along from the door second end towards the door first end.

24. The storage unit as defined in claim 20 and further including a mechanism for facilitating moving the door to the fully open position.

25. The storage unit as defined in claim 20 and the door extending in a convex manner from the first to the second end thereof for permitting an enlargement of the enclosed article storage area.

26. A storage system, comprising:
a plurality of storage units placed on a ground surface and closely adjacent each other wherein each storage includes a housing having a bottom end for placement on the ground surface and side walls and an end wall integral therewith and extending upward therefrom to a top end perimeter edge, the bottom end defining an article retaining surface and having a front edge sized to facilitate the sliding or rolling thereon of an article by the user from the ground surface onto the article retaining surface,
a door moveably secured to the housing and movable between a closed position and a fully open position, and when in the closed position the door defining together with the housing an outer perimeter surface urea defining an enclosed article storage area and when in the closed position the door having a first surface area thereof comprising a portion of the outer perimeter surface area extending above the bottom end article retaining surface and when moved to the fully open position the door first surface area being moved away from its position above the article retaining surface to facilitate placement by the user of the article thereon,
a user operable locking mechanism for securing the door to the housing and preventing access to the article storage area by individuals other than the user.

27. The storage unit as defined in claim 26 and the door being sufficiently transparent to permit viewing of an article in the enclosed article storage urea when the door is in the closed position.

28. The storage unit as defined in claim 26 and the door having a handle secured thereto and extending there along from the door second end towards the door first end.

29. The storage unit as defined in claim 26 and further including a mechanism for facilitating moving the dour to the fully open position.

30. The storage unit as defined in claim 26 and the door extending in a convex manner from the first to the second end thereof for permitting an enlargement of the enclosed article storage area.
